(19) United States
(12) Patent Application Publication
(10) Pub. No.: US 2014/0069242 A1
(43) Pub. Date: Mar. 13, 2014

(54) ADJUSTING STRUCTURE OF A TORQUE WRENCH

(71) Applicant: Tien-Lung Lin, TAICHUNG (TW)

(72) Inventor: Tien-Lung Lin, TAICHUNG (TW)

(73) Assignee: TORQUE-TECH PRECISION CO., LTD., TAICHUNG (TW)

(21) Appl. No.: 13/607,831

(22) Filed: Sep. 10, 2012

(51) Int. Cl. B25B 23/142

(52) U.S. Cl. 81/467

(57) ABSTRACT

An adjusting structure of a torque wrench includes an adjusting bolt orderly installed with a first nut, a second nut, a connecting ring and a third nut. The second nut has a polygonal groove correspondingly engaged with a polygonal projected ring of the connecting ring, so that the connecting ring has a thicker wall, compared to a conventional one, to step up its strength. Therefore, the connecting ring has a stronger structure to avoid disadvantage of easily breaking down happening in the conventional one.

### BACKGROUND OF THE INVENTION

1. Field of the Invention

This invention relates to an adjusting structure of a torque wrench.

2. Description of the Prior Art

As shown in FIGS. 1 and 2, a conventional torque wrench 100 includes an operating rod 10, a driving head 20, an adjusting structure 30 and a fixing member 40. The operating rod 10 consists of an inner tube 11 and an outer tube 12, with the inner tube 11 fitted inside the outer tube 12. The inner tube 11 has an exterior wall axially formed with plural restricting grooves 111 and the outer tube 12 has a through hole 121 bored through the wall, with the through hole 121 able to communicate with the restricting grooves 111. Near to the through hole 121 is a blocking member 122 extended out of the exterior wall of the outer tube 12. The driving head 20 is pivotally fixed with one end of the inner tube 11, provided with an extending arm 21 stretched inside the inner tube 11. The adjusting structure 30 is installed in the operating rod 10, provided with a leaning member 31 located at the front to rest against the extending arm 21, an elastic member 32 placed next to the leaning member 31, and an adjusting bolt 33 laid next to the elastic member 32. The adjusting bolt 33 has a head 331 resting on the elastic member 32, and a tail 332 projected outside the inner tube 11. In addition, the adjusting bolt 33 is threadably engaged with a first nut 34 fixed at the inner wall of the inner tube 11. A second nut 35, a connecting ring 36 and a third nut 37 are orderly installed on the adjusting bolt 33 in a direction from the head 331 of the adjusting bolt 33 to the tail 332 of the adjusting bolt 33. The connecting ring 36 is annularly fitted between the second nut 35 and the third nut 37, fixed at the inner wall of the outer tube 12. The fixing member 40 is outwardly fitted around the operating rod 10, provided with a steel ball 41 deposited in the through hole 121, and a sliding sleeve 42 able to move along the outer tube 12. The sliding sleeve 42 is further provided with a recess 421 cut in the inner wall, and a projection 422 abutting upon the recess 421. Moreover, a spring 43 is confined between the blocking member 122 of the outer tube 12 and the projection 422. So a user can rotate the outer tube 12 to enable the adjusting bolt 33 to screw with the first nut 34, so as to adjust pressure of the elastic member 32 compelled to the leaning member 31, for the purpose of adjusting torque value of the torque wrench 100.

However, in order to enable the connecting ring 36 to drive the second nut 34 for consecutively rotating the adjusting bolt 33, the connecting ring 36 needs to have a central portion of one side bored axially along the adjusting bolt 33 with a through hole 361 for accommodating the second nut 35. As a result, a wall thickness d1 measured between the inner wall and the outer wall of the connecting ring 36 is not thick enough to avoid from breaking down after operating the torque wrench 100 a certain period of time, disabling the torque wrench 100 from adjusting torque value. Moreover, as the through hole 361 is shaped as exactly the same as that of the second nut 35 for better dynamic transfer, it is not apt to engage the second nut 35 with the connecting ring 36 unless the second nut 35 is rotated precisely to a specific angle to move into the through hole 361.

### SUMMARY OF THE INVENTION

The object of this invention is to offer an adjusting structure of a torque wrench. The adjusting structure includes a connecting ring possessing a thick wall for advancing its strength, able to avoid disadvantage of easily breaking down happening in the conventional one, largely promoting durability of the torque wrench.

Except the adjusting structure, the torque wrench includes an operating rod consisting of an inner tube and an outer tube, and a driving head provided with an extending arm pivotally inserted in one side of the inner tube.

The adjusting structure is provided with a leaning member located at a front to rest against the extending arm, an elastic member placed next to the leaning member opposite to the extending arm, and an adjusting bolt laid next to the elastic member. The adjusting bolt is further provided with a head resting on the elastic member, and a tail projected outside the inner tube. And the adjusting bolt is threadably engaged with a first nut fixed at an inner wall of the inner tube. A second nut, a connecting ring and a third nut are orderly installed on the adjusting bolt in a direction from the head to the tail. The connecting ring is annularly fitted between the second nut and the third nut, fixed at an inner wall of the outer tube. Furthermore, the second nut is provided with a polygonal groove dug axially along the adjusting bolt to correspond to a center of one side of the connecting ring. And the connecting ring is provided with a polygonal projected ring formed at one side of the second nut to correspondingly engage with the polygonal groove.

With the polygonal groove of the second nut correspondingly engaged with the polygonal projected ring of the connecting ring to make the connecting ring and the second nut engaged with each other, the connecting ring has a wall thickness thicker than that of the conventional one, under a condition of keeping the inner diameter of the outer tube the same. So, unlike the connecting ring of the conventional torque wrench, the connecting ring of the invention has a stronger structure to avoid from easily breaking down, largely promoting durability of the present torque wrench.

### BRIEF DESCRIPTION OF DRAWINGS

This invention is better understood by referring to the accompanying drawings, wherein:

FIG. 1 is a cross-sectional view of a conventional torque wrench;

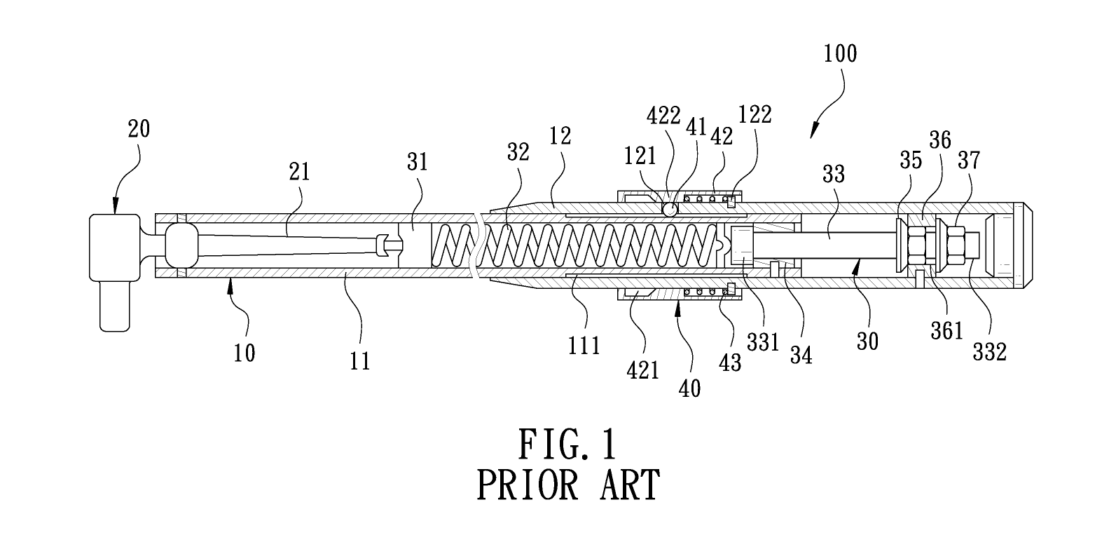

FIG. 2 is a partial magnified cross-sectional view of the conventional torque wrench;

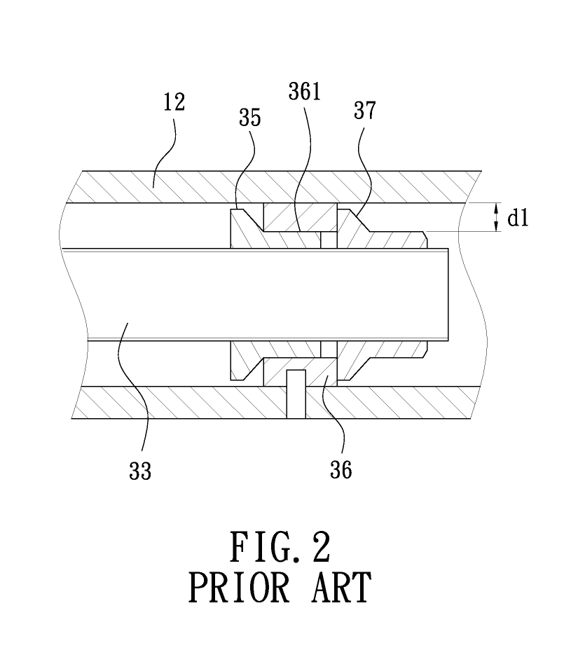

FIG. 3 is a cross-sectional view of a preferred embodiment of an adjusting structure of a torque wrench in the present invention;

FIG. 4 is a partial magnified cross-sectional view of the preferred embodiment of an adjusting structure of a torque wrench in the present invention;

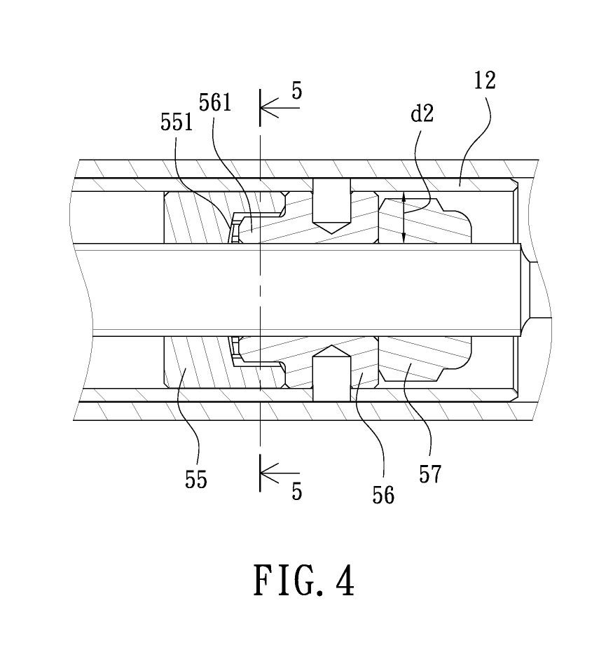

FIG. 5 is a cross-sectional view of a “5-5” line in FIG. 4; and

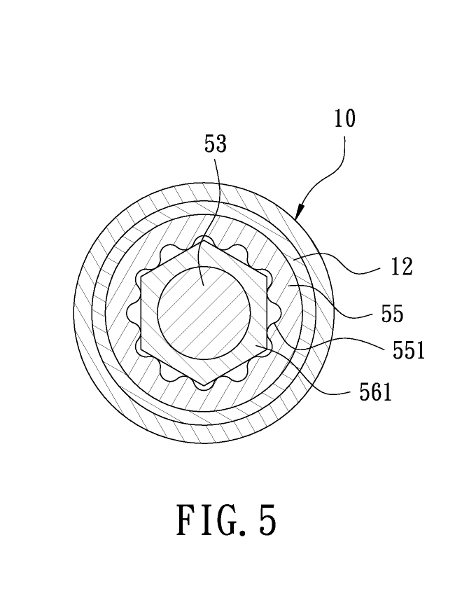

FIG. 6 is a cross-sectional view of the preferred embodiment of an adjusting structure of a torque wrench in the present invention, showing it being operated.

### DETAILED DESCRIPTION OF THE

### Preferred Embodiment

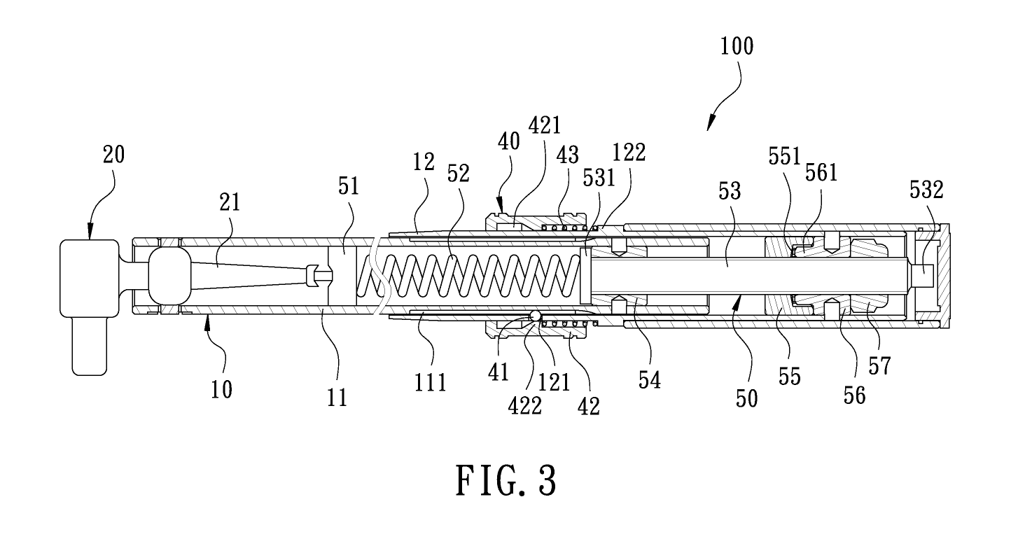

FIGS. 3˜5 show a preferred embodiment of an adjusting structure 50 of a torque wrench 100 in the present invention. The torque wrench 100 is additionally provided with an operating rod 10, a driving head 20 and a fixing member 40, which have the same structures as those mentioned in the prior art, so they are labeled likewise for convenient description. The adjusting structure 50 is installed in the operating rod 10, provided with a leaning member 51 located at the front to rest against an extending arm 21, an elastic member 52 placed next to the leaning member 51, and an adjusting bolt 53 laid next to the elastic member 52. The adjusting bolt 53 has a head 531 resting on the elastic member 52, and a tail 532 projected outside an inner tube 11. In addition, the adjusting bolt 53 is threadably engaged with a first nut 54 fixed at the inner wall of the inner tube 11. A second nut 55, a connecting ring 56 and a third nut 57 are orderly installed in a direction from the head 531 of the adjusting bolt 33 to the tail 532 of the adjusting bolt 53. The connecting ring 56 is annularly fitted between the second nut 55 and the third nut 57, fixed at the inner wall of an outer tube 12. Furthermore, the second nut 55 is provided with a polygonal groove 551 dug axially along the adjusting bolt 53 to correspond to a center of one side of the connecting ring 56. And the connecting ring 56 is provided with a polygonal projected ring 561 formed at one side of the second nut 55 to correspondingly engage with the polygonal groove 551. In this embodiment, the polygonal groove 551 is formed like a star with 12 angled recesses and the polygonal projected ring 561 is formed hexagonal.

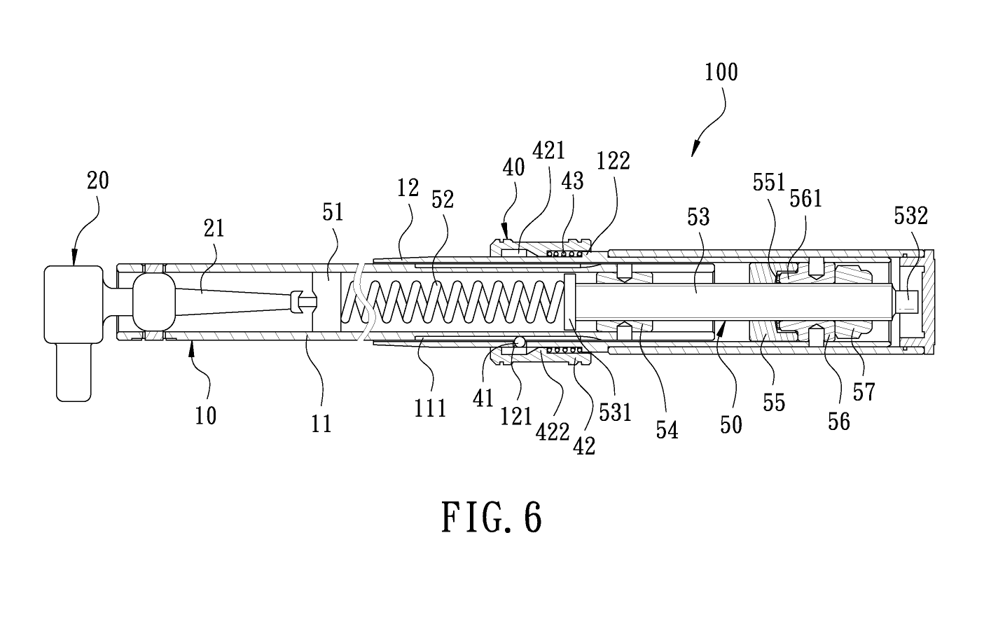

As shown in FIG. 6, when a user is to adjust torque value of the torque wrench 100, he first needs to move the sliding sleeve 42 of the fixing member 40 heading toward the tail 532 of the adjusting bolt 53, enabling the steel ball 41 to move to the recess 421 so as to be freed from the restricting grooves 111. Next, the outer tube 12 of the operating rod 10 can be rotated against the inner tube 11. By the time, with the first nut 54 fixed at the inner wall of the inner tube 11 and the connecting ring 56 fixed at the inner wall of the outer tube 12, and with the connecting ring 56 fitted between the second nut 55 and the third nut 57, the outer tube 12 is able to drive the connecting ring 56 to whirl, and consecutively enabling the second nut 55 and the third nut 57 to rotate as well. So the adjusting rod 53 can correspondingly move along the first nut 54 for adjusting pressure forced on the leaning member 51 by the elastic member 52. In this embodiment, the head 531 of the adjusting rod 53 is moved toward the leaning member 51 to compress the elastic member 52, with the pressure forced on the leaning member 51 by the elastic member 52 enhanced to enlarge torque value of the torque wrench 100.

It is to be noted that, with the polygonal groove 551 of the second nut 55 correspondingly fitted with the polygonal projected ring 561 of the connecting ring 56 to make the connecting ring 56 and the second nut 55 engaged with each other, a wall thickness d2 measured between the inner wall and the outer wall of the connecting ring 56 is comparatively thicker than the wall thickness d1 measured in the conventional torque wrench, under a condition of keeping the inner diameter of the outer tube 12 the same. So, unlike the connecting ring 36 of the conventional torque wrench, the connecting ring 56 has a structure with more strength to avoid from easily breaking down, largely promoting durability of the present torque wrench 100.

And it is to be further noted that, with the polygonal groove 551 formed like a star with 12 angled recesses and with the polygonal projected ring 561 formed hexagonal, the polygonal projected ring 561 possesses a chance to move into the polygonal groove 551 as the connecting ring 56 is rotated only with 30 degrees. That is, the polygonal projected ring 561 can easily engage with the polygonal groove 551, effectively improving the conventional disadvantage that the second nut 35 cannot engage with the connecting ring 36 unless they are moved to precisely correspond to each other.

While the preferred embodiment of the invention has been described above, it will be recognized and understood that various modifications may be made therein and the appended claims are intended to cover all such modifications that may fall within the spirit and scope of the invention.

What is claimed is:

1. An adjusting structure of a torque wrench, said torque wrench comprising:
an operating rod consisting of an inner tube and an outer tube;
a driving head provided with an extending arm pivotally inserted in one side of said inner tube;
said adjusting structure provided with a leaning member located at a front to rest against said extending arm, an elastic member placed next to said leaning member opposite to said extending arm, an adjusting bolt laid next to said elastic member and provided with a head resting on said elastic member and a tail projected outside said inner tube, said adjusting bolt further threadably engaged with a first nut fixed at an inner wall of said inner tube, a second nut and a connecting ring and a third nut orderly installed on said adjusting bolt in a direction from said head of said adjusting bolt to said tail of said adjusting bolt, said connecting ring annularly fitted between said second nut and said third nut and fixed at an inner wall of said outer tube; and
said adjusting structure mainly characterized by having a polygonal groove dug axially along said adjusting bolt in one side of said second nut to correspond to a center of one side of said connecting ring, said connecting ring provided with a polygonal projected ring formed at one side to correspondingly engage with said polygonal groove of said second nut.

2. The adjusting structure of a torque wrench as claimed in claim 1, wherein said polygonal groove is formed like a star with 12 angled recesses and said polygonal projected ring is formed hexagonal.
